(19) United States
(12) Patent Application Publication
(10) Pub. No.: US 2006/0293850 A1
(43) Pub. Date: Dec. 28, 2006

(54) Method for providing navigation service by using mobile station based global positioning system and mobile communication terminal and system using the same

(75) Inventors: Byungik Ahn, Seongnam-si (KR); Myoungjin Shin, Dongjak-gu (KR); Hyunwoo Choi, Gwangjin-gu (KR)

Correspondence Address: LAHIVE & COCKFIELD, LLP, ONE POST OFFICE SQUARE, BOSTON, MA, 02109-2127, US

(73) Assignee: POINT-I Co., LTD., Gangnam-gu (KR)

(21) Appl. No.: 11/342,052

(22) Filed: Jan. 27, 2006

(30) Foreign Application Priority Data
Mar. 29, 2005 (KR) 2005-25817

(51) Int. Cl. G01C 21/30

(52) U.S. Cl. 701/213; 701/210

(57) ABSTRACT

Disclosed is a method for providing a navigation service by using a MS-Based GPS scheme in a mobile communication system including a mobile communication terminal, a PDE, a LBS platform and a road guidance service server, which comprising: (a) the road guidance service server selecting a road guidance service mode, receiving information of a starting point and a destination of the mobile communication terminal through the LBS platform, and receiving request signals for travel route information; and (b) generating the travel route information according to the received request signals, and transmitting the travel route information to the mobile communication terminal, wherein the road guidance service server computes a shortest travel route, transmits the shortest travel route to the mobile communication terminal, and, when a vehicle deviates from a travel route, the road guidance service server re-searches for a route to the destination, and transmits the travel route to the mobile communication terminal.

### FIELD OF THE INVENTION

The present invention relates to a method for providing a road guidance service by using a Mobile Station (hereinafter, referred to as MS)-based Global Positioning System (hereinafter, referred to as GPS) scheme, and a mobile communication terminal and a system using the same. Specifically, the present invention relates to a method for providing a road guidance service by using a MS-based GPS scheme, and a mobile communication terminal and a system using the same, wherein the MS-based GPS scheme provides a travel route service for generating the shortest travel route desired by a user from a starting point to a destination by means of location information determined by a mobile communication terminal, and outputting travel route information including the generated shortest travel route.

### BACKGROUND OF THE INVENTION

Recently, a wireless Internet service has emerged, which can provide mobile communication terminals with a data communication service using the Internet in addition to character and voice services. With the development of technology relating to a mobile communication terminal and the rapid increase in the supply rate of the mobile communication terminal, wireless Internet environments have been increasingly developed. Further, a wireless Internet service has emerged, which can provide mobile communication service subscribers with an Internet communication service through a wireless communication network in order to provide a communication service without spatial limitation. Therefore, numerous enterprises have been developing a wireless Internet technology. A wireless Internet service is an advanced personalization service based on the use of a terminal by an individual, and is characterized in that it is a service capable of providing specific information based on the user mobility. Mobile communication service subscribers may receive various information, such as news, weather, sports, stock, an exchange rate and traffic information, through characters, voice, still images, dynamic images, etc.

Among various wireless Internet services using mobile communication terminals, Location Based Services (hereinafter, referred to as LBS) is in the spotlight due to its wide availability and convenience. The LBS represents a communication service for understanding the location of a mobile communication terminal such as a cell phone, a Personal Digital Assistant (PDA) and a notebook PC, and providing supplementary information relating to the location. The LBS may be applied to various fields and situations such as a rescue request, countermeasure for reporting of a crime, a Geographical Information System (GIS) for providing adjacent region information, differentiation of mobile communication cost dependent on locations, traffic information, vehicle navigation and physical distribution control, and a location-based Customer Relationship Management (CRM).

In order to use the LBS, it is essential to understand the location of a wireless communication terminal. A technology of understanding the location of a wireless communication terminal is called a Position Determination Technology (hereinafter, referred to as PDT), which may be classified into a network-based technology of understanding the location of a terminal by means of the location of a base station and a handset-based technology of tracking the location of an apparatus by means of GPS satellite signals. Recently, a hybrid technology of improving the location accuracy by mixing the two technologies has been developed.

The network-based technology performs location tracking based on an existing cellular network, and tracks a cell-ID or understands the location of a user through distance determination between a base station and a mobile body. Since it is not necessary to add a new module to an existing mobile communication terminal, addition cost is not needed in developing a mobile communication terminal. However, the network-based technology contains an inaccuracy to the extent that a location error reaches about 500 m˜several km according to cell sizes of a wireless base station or location determination schemes. In the handset-based technology, a mobile communication terminal introduces a technology capable of understanding the location of the terminal. The handset-based technology receives the electric wave transmitted from three or more satellites of the 24 satellites managed by the US Department of Defense, and understands the location in terms of latitude and longitude.

Since the network-based technology has an error approximately equal to the radius of a cell, i.e. several km, it is impossible to accurately track a location. However, if a GPS system or a DGPS system is used, the network-based technology can provide relatively accurate location information having an error of about several m˜several tens of m. In the present time, the handset-based technology using GPS signals has been generalized and used as a method for understanding a location through wireless communication.

A GPS represents a system capable of understanding locations of all places around the world by means of 24 GPS artificial satellites revolving within the Earth's orbit at a height of about 20,000 km.

A GPS uses electric wave of 1.5 GHz band. A control center called a control station on the ground collects information transmitted from GPS satellites, and synchronizes the collected information. A user understands the current location through a GPS receiver.

It is common that a trigonometric measurement method is used as a method for understanding a location by means of a GPS system. For trigonometric measurement, three satellites are necessary. However, one observation satellite is necessary for a time error. Accordingly, a total of four satellites are necessary.

A Time To First Fix (TTFF), which is an actual time required when a GPS receiver determines its own location for the first time, may occasionally require about several minutes to several tens of minutes. Therefore, location-based wireless Internet service users may be inconvenienced.

In order to compensate for the disadvantage of the GPS scheme, an A-GPS scheme has been developed for use, which combines the GPS scheme with resources of a mobile communication network, and determines the location of a mobile communication terminal.

In an A-GPS scheme, a mobile communication terminal simultaneously collects information necessary for location determination from a GSP artificial satellite and a mobile communication network, so that the mobile communication terminal can three-dimensionally determine its own location. The mobile communication network and the mobile communication terminal transmits or receives data or messages by means of parameters defined in an IS-801-1 standard. An A-GPS scheme may be classified into an MS-Assisted Network-Based GPS (hereinafter, referred to as MS-Assisted GPS) scheme and an MS-Based Network-Assisted GPS (hereinafter, referred to as MS-Based GPS) scheme. All of the MS-Assisted GPS scheme and the MS-Based GPS scheme receive aiding data from a predetermined Positioning Determination Entity (hereinafter, referred to as PDE) in order to determine the location of a mobile communication terminal, and acquire GPS electric wave from one or more artificial satellite.

In a location determination after acquiring the GPS electric wave, the two schemes show a difference. According to the MS-Assisted GPS scheme, if the acquired GPS electric wave is transmitted to a mobile communication network, a predetermined PDE installed in the mobile communication network receives the GPS electric wave, determines the longitude and latitude coordinates of a mobile communication terminal, and transmits the determined longitude and latitude coordinates to the mobile communication terminal.

According to the MS-Based GPS scheme, longitude and latitude coordinates are determined with reference to GPS electric wave received in a mobile communication terminal. Further, when it is not necessary to update aiding data values or download a map, the longitude and latitude coordinates are not transmitted to a PDE.

In the LBS using the GPS, a navigation service is in the spotlight, which displays information, such as the shortest distance from the current location of a mobile communication terminal to a destination and the current location of the terminal while moving, on the mobile communication terminal by means of GPS signals in the form of a two dimensional graphic or a three dimensional graphic.

A navigation service is mainly used for vehicles, ships, airplanes, etc. A wireless data service for providing information to these transport means while they are moving is called a telematics system. Recently, a field for which the LBS has been actively utilized corresponds to the telematics system for applying the LBS to a mobile body such as a vehicle.

A telematics system corresponds to a wireless data service capable of exchanging information with computers installed in transport means, such as vehicles, airplanes and ships, in the form of character signals, voice signals, etc., through a wireless communication technology, a satellite navigation apparatus, or the Internet. Specifically, a vehicle telematics system applies a mobile communication technology and a location tracking technology to vehicles, and provides drivers with vehicle accident information, a burglary detection, a driving route guidance, traffic and life information, games, etc., in real-time.

A telematics system has mainly provided simple functions including a location search or a route setup. However, a telematics system has increasingly opened up application fields, so that it has been applied to emergency notification, a remote door locking system, a remote diagnosis and a multimedia field through Internet access.

Typically, mobile bodies, such as ships, vehicles and airplanes, employing a telematics system have used a navigation service. A navigation service includes a route search and guidance function for detecting the current location of a mobile body with reference to both signals received from multiple GPS satellites belonging to a location information system and signals detected from multiple sensors including a gyro sensor for detecting a travel direction of the mobile body and a speed sensor for detecting the traveling speed of the mobile body, these sensors being installed on the mobile body, harmonizing the detected current location of the mobile body with map data, searches for a travel route from the current location to a destination through the map data, and allowing the mobile body to arrive at the destination along the searched travel route. The map data may be stored in a storage medium of a terminal (navigator) mounted on the mobile body and used. Further, a method has been used, which interconnects a server for providing the map data with the terminal mounted on the mobile body through a wireless network, and receives only map data around the current travel location of the mobile body through the wireless network. In addition, there exists a method for showing a route computed by a vehicle terminal displaying a route on map data, and a method for receiving an optimal route considering traffic situations, etc., from a service provider. A system, which receives map data, optimal route data, etc., from a service provider by utilizing a wireless network, can more actively cope with traffic situations.

In markets of mobile telematics for providing both traffic information including road guidance and adjacent geography information by means of a mobile communication terminal as described above, wireless communication network providers have keenly competed with one another, and new products have been continuously released.

A conventional navigation service using a mobile communication terminal includes the mobile communication terminal storing Wireless Internet Platform for Interoperability (hereinafter, referred to as WIPI) and a GPS kit having a navigation kit, a terminal cradle, a GPS antenna, etc., and provides a road guidance service by means of a speaker and a LCD screen of the mobile communication terminal. The GPS kit receives navigation data through a GPS receiver, stores road information in a flash memory, and provides the road information to the mobile communication terminal.

The WIPI is a Korean standard for a wireless Internet platform, is similar to middleware stored in a mobile communication terminal, and is used when operating or downloading various applications like an operating system of a PC. The WIPI can provide a developer of terminal applications with compatibility of contents among platforms, provide a terminal developer with easiness of platform porting, and provide a general user with various and plentiful contents services.

However, in order to use a road guidance service in a mobile communication terminal, it is necessary to purchase an expensive GPS kit in addition to the mobile communication terminal. Further, a process for operating the mobile communication terminal and the GPS kit in order to use the road guidance service is complicated.

Moreover, in environments in which a user does not use other traffic means in addition to vehicles, or an apparatus such as a GPS kit, the user cannot use a road guidance service only with the mobile communication terminal. That is, mobility is limited.

### SUMMARY OF THE INVENTION

Accordingly, the present invention has been made to solve the above-mentioned problems occurring in the prior art, and it is an object of the present invention to provide a system for providing a travel route service for generating the shortest travel route desired by a user from a starting point to a destination by means of location information determined by a mobile communication terminal, and outputting travel route information including the generated shortest travel route.

It is another object of the present invention to provide a method for providing a travel route service for generating the shortest travel route desired by a user from a starting point to a destination by means of location information determined by a mobile communication terminal, and outputting travel route information including the generated shortest travel route.

It is further another object of the present invention to provide a road guidance service for generating the shortest travel route desired by a user from a starting point to a destination by means of location information determined by a mobile communication terminal, and transmitting the generated shortest travel route to the mobile communication terminal, thereby providing a travel route service.

It is still another object of the present invention to determine location information from a GPS artificial satellite by means of aiding data received from a road guidance service server for transmission, request the road guidance service server to transmit travel route information desired by a user from a starting point to a destination, receive the travel route information from the road guidance service server, and output the received travel route information.

In order to accomplish these object, there is provided a method for providing a navigation service by means of a Mobile Station (MS) MS-Based Global Positioning System (GPS) scheme in a mobile communication system including a mobile communication terminal, a Positioning Determination Entity (PDE), a Location Based Services (LBS) platform and a road guidance service server, the method including the steps of: (a) the road guidance service server selecting a road guidance service mode, receiving information of a starting point and a destination of the mobile communication terminal through the LBS platform via a mobile communication network, and receiving request signals for travel route information; and (b) generating the travel route information according to the received request signals, and transmitting the travel route information to the mobile communication terminal through the mobile communication network, wherein the road guidance service server computes a shortest travel route by means of a Dijkstra algorithm based on a R-Tree, transmits the shortest travel route to the mobile communication terminal, and, when a vehicle deviates from a travel route received from the road guidance service server during traveling, the road guidance service server re-searches for a route to the destination in a progressing direction of the vehicle, and transmits the re-searched travel route to the mobile communication terminal.

In order to accomplish these object, there is provided a system for providing a navigation service by means of a Mobile Station (MS) MS-Based Global Positioning System (GPS) scheme, the system including: a mobile communication terminal for receiving GPS electric wave from a GPS artificial satellite by means of aiding data received through a mobile communication network, determining location information of a user, transmitting the determined location information through the mobile communication network, and receiving and outputting travel route information from a starting point, which corresponds to the location information, to a destination; a Positioning Determination Entity (PDE) for generating the aiding data by means of Mobile Station (MS) information received from the mobile communication terminal, and transmitting the generated aiding data to the mobile communication terminal; a road guidance service server for receiving the location information, generating the travel route information from the starting point to the destination by means of the received location information, and transmitting the generated travel route information to the mobile communication terminal; and a Location Based Services (LBS) platform for receiving the location information from the mobile communication terminal, transmitting the received location information to the road guidance service server, transmitting request signals of the mobile communication terminal for the travel route information from the starting point to the destination to the road guidance service server, receiving the travel route information, and transmitting the received travel route information to the mobile communication terminal, wherein the road guidance service server computes a shortest travel route by means of a Dijkstra algorithm based on a R-Tree, transmits the shortest travel route to the mobile communication terminal, and, when a vehicle deviates from a travel route received from the road guidance service server during traveling, the road guidance service server re-searches for a route to the destination in a progressing direction of the vehicle, and transmits the re-searched travel route to the mobile communication terminal.

In order to accomplish these object, there is provided a road guidance service server for receiving determined location information from a mobile communication terminal, generating a shortest travel route from a starting point to a destination, which is desired by a user, transmitting the generated the shortest travel route to the mobile communication terminal, thereby providing a travel route service, the road guidance service server including: a travel route supply unit for generating travel route information from the starting point to the destination, which has been requested by the mobile communication terminal, and generating data for voice guidance based on the generated travel route information; a gateway for receiving request signals for the travel route service from the mobile communication terminal, generating the travel route information through inter-working with an authentication server, an accounting server, a Location Based System Platform (LBSP) of a wireless communication network provider, the travel route supply unit, and transmitting the generated travel route information to the mobile communication terminal; and a controller for controlling a general processor operation and management of the road guidance service server, analyzing and operating materials generated from various modules included in the road guidance service server, storing the analyzed materials as database information for management, and controlling the travel route information necessary for traveling of a vehicle to be transmitted to the mobile communication terminal.

In order to accomplish these object, there is provided a mobile communication terminal for determining location information from a GPS artificial satellite by means of aiding data received from a road guidance service server, transmitting the location information, requesting the road guidance service server to transmit travel route information from a starting point to a destination, which is desired by a user, receiving the travel route information from the road guidance service server, and transmitting the travel route information, the mobile communication terminal including: a communication controller for maintaining and releasing call connection with the road guidance service server, and managing and controlling a flow of transmitted/received data; a navigation controller for receiving the travel route information from the starting point to the destination from the road guidance service server, storing, processing and managing the received travel route information, and displaying the travel route from the starting point to the destination on a LCD screen of the mobile communication terminal by voice, a map and a route; and a location information controller for receiving request signals for a current location information, determining the location information from the GPS artificial satellite, transmitting the location information to a corresponding module, and storing and managing distance and angle data of periodically collected coordinates.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the construction of a system for providing a road guidance service by means of a MS-Based GPS scheme according to a preferred embodiment of the present invention;

FIG. 2a is a diagram illustrating a scheme for computing an MBR using starting point and destination location information;

FIG. 2b is a diagram illustrating a method for determining a search area according to an embodiment of the present invention, which shows MBR and Heuristic areas;

FIG. 3 is a diagram illustrating a method used when a road guidance service server computes a travel route in a progressing direction in a re-search process of a route according to an embodiment of the present invention;

FIG. 4 is a block diagram schematically illustrating the construction of a road guidance service server for providing a road guidance service by means of a MS-Based GPS scheme according to a preferred embodiment of the present invention;

FIG. 5 is a block diagram schematically illustrating the construction of a mobile communication terminal for providing a road guidance service by means of a MS-Based GPS scheme according to an embodiment of the present invention; and

FIG. 6 is a flow diagram schematically illustrating a method for providing a road guidance service by means of a MS-Based GPS scheme according to a preferred embodiment of the present invention.

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same elements as those in other drawings. In the following description of the present invention, a detailed description of known configurations and functions incorporated herein will be omitted when it may make the subject matter of the present invention rather unclear.

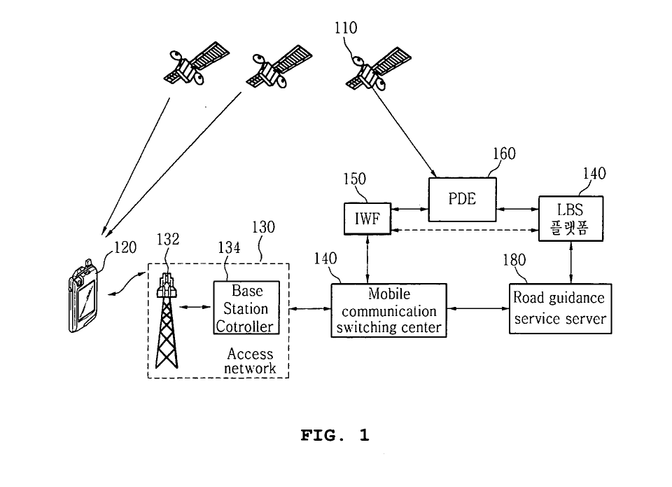

FIG. 1 is a block diagram illustrating the construction of a system for providing a road guidance service by means of a MS-Based GPS scheme according to a preferred embodiment of the present invention.

The system for providing the road guidance service by means of the MS-Based GPS scheme according to the preferred embodiment of the present invention includes a GPS artificial satellite 110, a mobile communication terminal 120, a wireless access network 130, a mobile communication switching center 140, an inter-working function 150, a Positioning Determination Entity (hereinafter, referred to as PDE) 160, an LBS platform 170, a road guidance service server 180, etc.

The GPS artificial satellite 110 is a satellite used when a GPS understands the location of the mobile communication terminal 120, which includes 24 satellites for continuously transmitting navigation data necessary for location computation to the mobile communication terminal 120 through carrier wave. Among these satellites, 21 satellites are used for navigation and the other three satellites are reserved for preliminary use.

Such an arrangement of the GPS artificial satellite 110 is designed such that at least four satellites always have a line of sight across all the area in Earth in order to compute a three dimensional location of the mobile communication terminal 120 and an error of a clock installed in the mobile communication terminal 120.

Data transmitted from the GPS artificial satellite 110 through electric wave include a Pseudo Random Noise (PRN) code uniquely designed according to numbers of the GPS artificial satellite 110. That is, since the navigation data are transmitted to the mobile communication terminal 120 through GPS electric wave transmitted from the GPS artificial satellite 110 by means of a Code Division Multiple Access (CDMA) scheme, the mobile communication terminal 120 can clearly receive the navigation data transmitted from the GPS artificial satellite 110.

The mobile communication terminal 120 is connected to a mobile communication network through the wireless access network 130, and provides a voice communication function for allowing the mobile communication terminal 120 to perform typical voice communication with another mobile communication terminal through wireless communication. In addition, the mobile communication terminal 120 can access to the Internet through an embedded web browser, etc. Further, the mobile communication terminal 120 represents a terminal capable of providing a navigation service for receiving GPS signals from the GPS artificial satellite 110 through a GPS receiver installed in the mobile communication terminal 120 or a GPS receiver separately provided to the mobile communication terminal 120, and displaying information, such as the shortest distance from the current location of the mobile communication terminal 120 to a destination, the current location of the terminal 120 while moving, in the form of a two dimensional graphic or a three dimensional graphic.

The mobile communication terminal 120 includes a Personal Digital Assistant (PDA), a cellular phone, a Personal Communication Service (PCS) phone, a Global System for Mobile (GSM) phone, a Wideband-CDMA (W-CDMA) phone, a CDMA-2000 phone, a Mobile Broadband System (MBS) phone, etc. The MBS phone corresponds to a mobile communication terminal to be used for a 4G system being currently discussed. Further, the mobile communication terminal 120 must include a browser used for data exchange as a means for accessing to the road guidance service server 180 through the mobile communication network. Such a browser may include a Wireless Application Protocol (WAP) browser based on a WAP, a Microsoft Internet Explorer (MIE) based on a HTML using a HTTP, a Handheld Device Transport Protocol (HDTP) I-mode, a Binary Runtime Environment for Wireless (BREW), a “NATE” of SK telecom Co., Ltd, etc. The present invention is not limited to these browsers.

The mobile communication terminal 120 transmits Mobile Station (MS) information to the PDE 160 through the mobile communication network in order to determine a location by means of an MS-Based Network-Assisted GPS (hereinafter, referred to as MS-Based GPS) scheme. The PDE 160 generates aiding data for determining the location of the mobile communication terminal 120 by means of the received MS information, and transmits the aiding data to the mobile communication terminal 120 through the mobile communication network. The MS information represents information regarding pilot chase ability, GPS acquisition ability, location computation ability, etc., of a terminal. The aiding data represents information regarding coordinate information, identification code information, etc., of the GPS artificial satellite 110.

The mobile communication terminal 120 receives GPS electric wave from one or more GPS artificial satellite 110 by means of the received aiding data, extracts navigation data from the received GPS electric wave, and determines its own location. After determining the location, the mobile communication terminal 120 transmits location information including longitude and latitude coordinates, etc., to the LBS platform 170 through the mobile communication network, and requests travel route information from a starting point to a destination. The LBS platform 170 receives the travel route information from the road guidance service server 180 inter-working with the LBS platform 170, transmits the travel route information to the mobile communication terminal 120 through the mobile communication network, and reports the travel route information by voice.

The mobile communication terminal 120 receives the aiding data from the PDE 160 every 30 or 120 minutes, updates the received aiding data, and determines its own location with a time cycle of two seconds. Further, the mobile communication terminal 120 includes a GPS receiver for receiving GPS information from the GPS artificial satellite 110, etc., generates location information by means of the received GPS information every predetermined time periods (two seconds, five seconds, 10 seconds, etc.), and stores the generated location information in a flash memory therein. When a request for the location information is received from the road guidance service server 180, the mobile communication terminal 120 may provide the location information through the mobile communication network.

The mobile communication terminal 120 stores a travel information assistant application used when the mobile communication terminal 120 accesses to the road guidance service server 180, exchange signals and data, and uses a travel route service. The travel information assistant application transmits the location information determined by the mobile communication terminal 120 to the LBS platform 170, receives the travel route information from the road guidance service server 180, and outputs the travel route information to the destination from the starting point to the mobile communication terminal 120 by images, characters, voice, etc. Further, the travel information assistant application may also be stored in a program memory in a production step of the mobile communication terminal 120, or may be downloaded from a mobile communication provider server through wireless Internet access, etc.

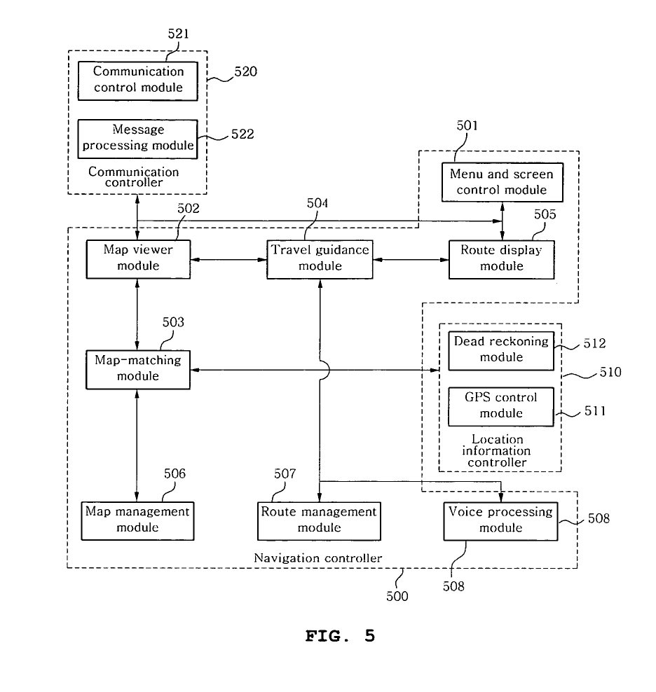

The construction of the mobile communication terminal 120 according to the preferred embodiment of the present invention will be described in detail with reference to FIG. 5.

The wireless access network 130 exchanges wireless signals and data with the mobile communication terminal 120, and includes a base station transmission system 132, a base station controller 134, etc.

The base station transmission system 132 transmits the location information received from the mobile communication terminal 120 to the base station controller 134. In addition, the base station transmission system 132 performs wire/wireless conversion, transmission/reception of wireless signals, etc., between the mobile communication terminal 120 and the base station controller 134, and corresponds to a network endpoint device directly connected to the mobile communication terminal 120. The base station controller 134 controls the base station transmission system 132, and performs a wireless channel assignment and release function of a paging channel, a traffic channel, etc., for the mobile communication terminal 120, a transmit power control function of the mobile communication terminal 120 and the base station transmission system 132, a determination function of soft handoff and hard handoff, a transcoding and vocoding function, a management and maintenance function for the wireless access network 130, etc.

The wireless access network 130 can support both a synchronous mobile communication system and an asynchronous mobile communication system. In the case of the synchronous mobile communication system such as a CDMA 2000 1× and a CDMA 2000 1× Evolution-Data Only (EV-DO), the base station transmission system 132 corresponds to a Base Transceiver Station (BTS) and the base station controller 134 corresponds to a Base Station Controller (BSC). In the case of the asynchronous mobile communication system such as a Wideband Code Division Multiple Access (WCDMA), the base station transmission system 132 corresponds to a Radio Transceiver Subsystem (RTS) and the base station controller 134 corresponds to a Radio Network Controller (RNC). The wireless access network 130 according to the preferred embodiment of the present invention is not limited to the synchronous or the asynchronous CDMA mobile communication system, and may include a GSM network and an access network of a 4G mobile communication system which is currently being standardized.

The mobile communication switching center 140 has a control function for efficient management of a wireless base station and an inter-working function with both a time division exchange installed in a Public Switched Telephone Network (hereinafter, referred to as PSTN) and the inter-working function 150. The mobile communication switching center 140 receives the data, which are transmitted from the mobile communication terminal 120, through the base station controller 134, and transmits the received data to the inter-working function 150 and the road guidance service server 180. Further, the mobile communication switching center 140 includes a plurality of time division exchanges, and performs a basic and supplementary service processing function, a function for processing a terminated call and an originating call of a subscriber, a location registration procedure and handoff procedure processing function, an inter-working function with another network, etc.

The mobile communication switching center 140 can support both an Interim Standard (IS)-95 A/B/C system and 3G/4G mobile communication networks.

The mobile communication switching center 140 may include an Access Switching Subsystem (ASS) for performing a distributed call processing function, an Interconnection Network Subsystem (INS) for performing a centralized call processing function, a Central Control Subsystem (CCS) for taking charge of a centralization function of operation and preservation, and a Location Registration Subsystem (LRS) for performing storage and management function of information for mobile communication subscribers, etc. Further, the mobile communication switching center 140 may include an Asynchronous Transfer Mode (ATM) switch in order to transmit packets by the cell and thus improve the transmission speed and the efficiency of a circuit use.

The inter-working function 150 is connected to the mobile communication switching center 140, provides an interface for data exchange between a wireless communication system and a wire communication system, converts protocols, signals and data in a form proper for each network, and performs an interface function for inter-working with a wire/wireless communication network including a mobile communication network, the Internet, a PSTN, a Packet Switched Public Data Network (PSPDN), etc.

The PDE 160 receives MS information such as the resolution of the wireless access network 130 from the mobile communication terminal 120, generates aiding data by means of the received MS information, and transmits the aiding data to the mobile communication terminal 120. For this, the PDE 160 includes a reference GPS antenna, receives MS information of the wireless access network 130 from the mobile communication terminal 120, searches for information (coordinate information, identification code information, etc.) of the GPS artificial satellite 110 for which the corresponding wireless access network 130 may receive GPS electric wave, generates aiding data, inserts the aiding data into the message “Provide Ephemeris” defined in an IS-801-1 standard, and transmits the message to the mobile communication terminal 120. That is, the PDE 160 and the mobile communication terminal 120 can exchange LBS-related data including the aiding data, etc., according to the IS-801-1 standard.

When the message “Provide Ephemeris” is received from the PDE 160, the mobile communication terminal 120 extracts the information of the GPS artificial satellite 110 included in the corresponding message, searches for the corresponding GPS artificial satellite 110, and receives GPS electric wave. The mobile communication terminal 120 having received GPS electric wave from one or more GPS artificial satellite 110 determines its own location, transmits the determined location information to the LBS platform 170 through the mobile communication network, and requests the road guidance service server 180 to transmit the travel route information by means of the location information.

The LBS platform 170 represents an application server capable of providing the mobile communication terminal 120 with various LBS services including the travel route service. The LBS platform 170 receives the determined location information from the mobile communication terminal 120, transfers the received location information to the road guidance service server 180, receives travel route information from a starting point of a user to a destination from the road guidance service server 180, and transmits the received travel route information to the mobile communication terminal 120 through the mobile communication network. Further, the LBS platform 170 may register, delete or modify various LBS information supply servers including the road guidance service server 180, and can perform an accounting function for the mobile communication terminal 120 using the LBS service, etc.

The road guidance service server 180 represents a Content Provider (CP) server for providing the mobile communication terminal 120 with the MS-Based GPS service, receives the location information of the mobile communication terminal 120 from the LBS platform 170, generates the travel route information from the starting point to the destination based on the received location information, and provides the mobile communication terminal 120 with the generated travel route information.

The travel route information provided by the road guidance service server 180 represents travel route information for road guidance to the destination from the current starting point, which may include the shortest travel route from the starting point to the destination, a travel speed and a direction of a car, and road information regarding a sharp curve area, an area where accidents occur frequently, a speed limit area, a fog area, etc. Further, the travel route information includes both route guidance data containing a travel route distance, the shortest travel route, a voice guidance type, a road type, a link index, etc., and route planning data containing a search area coordinate, map data, route data, etc., the search area coordinate containing starting point and destination coordinates.

The road guidance service server 180 receives starting point and destination location information from the LBS platform 170 inter-working with the PDE 160, and provides the mobile communication terminal 120 with the shortest travel route computed by means of a Dijkstra algorithm, which has employed an R-Tree concept according to the embodiment of the present invention, after setting the starting point and destination location information as search conditions.

The Dijkstra algorithm is an algorithm for setting a Minimum Bounding Rectangle (MBR) area and a Heuristic area, both of which contain R-Tree concept applied to an existing Dijkstra algorithm, as search areas of a starting point and a destination, computing travel route information by means of the Dijkstra algorithm in the set search areas, expressing spatial correlation among geography materials rapidly and exactly, easily processing a space analysis work of connection, adjacency, inclusion, etc., among the geography materials, and efficiently reducing or expanding search intervals, thereby computing the shortest travel route from the starting point and the destination.

The existing Dijkstra algorithm computes the shortest routes for all nodes from a starting point, and extracts the shortest route to a destination from the computed shortest routes. The Dijkstra algorithm, which has employed the R-Tree concept according to the embodiment of the present invention, sets the MBR and the Heuristic areas from the starting point to the destination as the search area in the afore-described Dijkstra algorithm, and computes the shortest travel route in the search area. The search area is determined by combining the MBR and the Heuristic areas using the R-tree, and doubly expanding the search area.

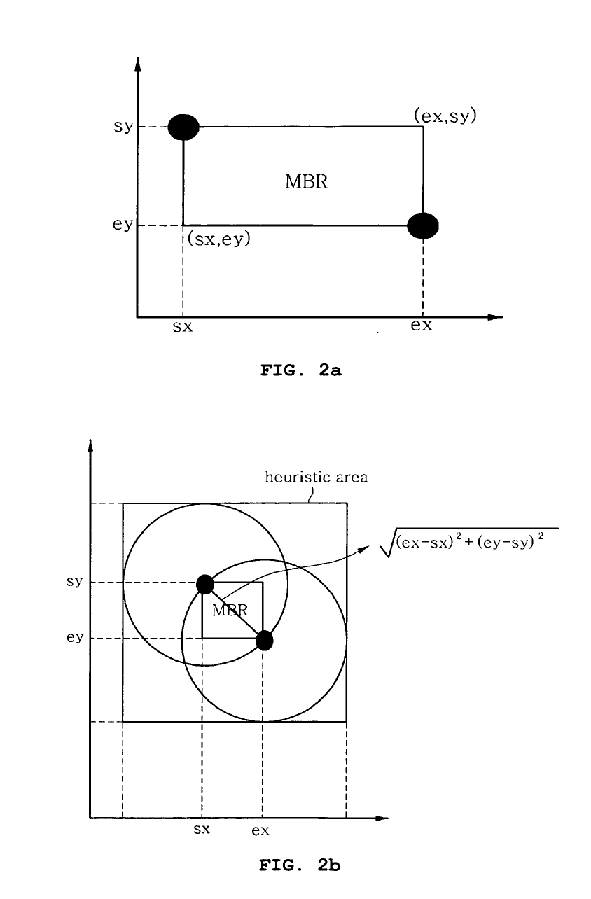

FIG. 2a is a diagram illustrating a scheme for computing an MBR using starting point and destination location information.

As illustrated in FIG. 2a, a starting point coordinate (sx, sy) and a destination coordinate (ex, ey) are determined, and an MBR area is determined as “MinX:=Min{sx, ex}, MinY:=Min{sy, ey}, MaxX:=Min{sx, ex}, MaxY:=Min{sy, ey}”.

In order to divide space-time, information of mobile objects from a starting point to a destination in the MBR area is made into space database. In order to index the space-time MBR, a space index is formed for geography materials by means of an R-Tree, the MBR area of a movement route is extracted by the page of the space index, and the extracted MBR area is stored in an index. Accordingly, an index scheme of an MBR area based on the R-Tree can reduce a search area from the starting point to the destination, and improve the efficiency of a storage space.

FIG. 2b is a diagram illustrating a method for determining a search area according to the embodiment of the present invention, which shows MBR and Heuristic areas.

As illustrated in FIG. 2b, a method for computing the length of the shortest route may be expressed by equation 1 below.
length (H) of the shortest route=\sqrt{(ex−sx)²+(ey−sy)²} Equation 1

Herein, the final search area (MBR and Heuristic areas) is computed by means of equation 1, a coordinate (sx, sy) of a starting point, and a coordinate (ex, ey) of a destination.

The computed final search area (MinX−H, MinY−H, MaxX+H and MaxY+H) is expressed as illustrated in FIG. 2b.

In the travel route service from the starting point to the destination according to the embodiment of the present invention, the search area is set by means of the Dijkstra algorithm, which has employed the R-Tree concept, as illustrated in FIG. 2b, and the shortest travel route is computed by means of the Dijkstra algorithm. The road guidance service server 180 computes the final search area, i.e. the shortest travel route from the starting point to the destination in the MBR area, by means of the Dijkstra algorithm using the R-Tree. When the road guidance service server 180 fails to compute the shortest travel route in the MBR area, the road guidance service server 180 expands the search area to the Heuristic area and computes the shortest travel route. In this way, the shortest travel route is computed with reference to two search areas, so that it is possible to quickly and efficiently compute the travel route.

The road guidance service server 180 compares link data for a node list computed by means of the Dijkstra algorithm, which has employed the R-Tree concept, with road attribute data, and generates travel route information. Herein, information for generating the travel route information includes the angle between links, a road type, a link type, the number of cross points, etc.

In the embodiment of the present invention, a method for determining a road type by means of the link data and the road attribute data as described above will be described.

(1) Overpass and Underpass Guidance

if (current attribute of road type == overpass and previous attribute of road type != overpass)

return overpass;

if (current attribute of road type = underpass and previous attribute of road type != underpass)

return underpass;

If the attribute of a road type in a previous link is not an overpass and the attribute of the road type in the current link is an overpass, an overpass is generated. If the attribute of the road type in the previous link is not an underpass and the attribute of the road type in the current link is an underpass, an underpass is generated.

(2) Overpass and underpass side road guidance

```
    if (number of nodes adjacent to current node > 2 and
current link type == connection road link and previous link
type != connection road link)
    for (int i = 0; I < number of nodes adjacent to current
node : i++)
    {
    road type = getRoadInfo (current node, adjacent node[i])
        if(attribute of road type == overpass)
    return overpass side road;
        if(attribute of road type == underpass)
    return underpass side road
    }
```

In the case that the number of nodes adjacent to the current node is larger than 2, the current node type is a connection road link and previous link is not the connection road link, if the type of a road connecting an adjacent node to the current node among nodes is an overpass an overpass side road is generated and if the type of a road is an underpass an underpass side road is generated.

(3) Express Highway Entrance Guidance

In a case in which the type of the current road is an express highway, the type of the current link is a connection road link, and the type of a previous road is not an express highway, or in a case in which the type of the current road is an express highway, the type of a previous road is not an express highway, and the type of a previous link is not a connection road link, when the number of actually connected links is two and the current link is located on the left side of the other link, a road type of “express highway entrance on the left side” is generated. When the current link is located on the right side of the other link, a road type of “express highway entrance on the right side” is generated. When the current link is not located on the left and right sides of the other link, a road type of “express highway entrance” is generated.

(4) Express Highway Exit Guidance

In a case in which the type of the current road is an express highway, the type of the current link is a connection road link, the type of a previous road is an express highway, and the type of a previous link is not a connection road link, or in a case in which the type of the current road is not an express highway, the type of a previous road is an express highway, and the type of a previous link is not a connection road link, when the number of actually connected links is two and the current link is located on the left side of the other link, a road type of “express highway exit on the left side” is generated. When the current link is located on the right side of the other link, a road type of “express highway exit on the right side” is generated. When the number of actually connected links is one, a road type of “express highway exit” is generated.

When the number of actually connected links is more than two, if the current link is in the 1˜5 o'clock direction, a road type of “express highway exit on the left side” is generated. If the current link is in the 6˜11 o'clock direction, a road type of “express highway exit on the left side” is generated. In other cases, a road type of “express highway exit” is generated.

(5) Branch point guidance

```
    if(type of current road == express highway and type of
current link == connection road link and type of previous road
is == express highway and type of previous link != connection
road link)
    {
    if(current link is located on the left side of another
link)
      return entrance into the left express highway;
    else
      return entrance to on the right express highway;
    }
```

In a case in which the type of the current road is an express highway, the type of the current link is a connection road link, the type of a previous road is an express highway, and the type of a previous link is not a connection road link, when the current link is located on the left side of another link, a road type of “entrance to the left express highway” is generated. When the current link is located on the right side of another link, a road type of “entrance to the right express highway” is generated.

(6) Left turn guidance

```
    if(direction of link == 9 o'clock and number of actual
links permitting an entrance <= 3)
    {
      return left turn;
    }
```

If the direction of a link is in the 9 o'clock direction and the number of actual links permitting an entrance is smaller than 3, a road type of “left turn” is generated.

(7) Right turn guidance

```
    if(direction of link == 3 o'clock and number of actual
links permitting an entrance <= 3)
    {
      return right turn;
    }
```

If the direction of a link is in the 3 o'clock direction and the number of actual links permitting an entrance is smaller than 3, a road type of “right turn” is generated.

(8) O'clock direction guidance

if(direction of link > 0)
{
return o'clock direction of link;
}

If the direction of a link is larger than 0, “what o'clock direction” of a link is generated.

(9) Going-straight guidance

if(direction of link == 0)
{
return going-straight
}

If the direction of a link is 0, the status of going-straight is generated.

When a vehicle does not travel along the travel route information from the starting point to the destination, which has been transmitted from the road guidance service server 180 through the mobile communication network, and deviates from the travel route, the road guidance service server 180 re-searches for and generates travel route information to the destination in the progressing direction of the vehicle.

For the re-search of the travel route by the road guidance service server 180, the mobile communication terminal 120 transmits the current coordinate, a destination coordinate, an o'clock direction angle in a progressing direction, a road type, etc. The road guidance service server 180 searches for links of the o'clock direction angle from a coordinate at the current point, and computes the travel route information.

When a vehicle deviates from a travel route during traveling, the road guidance service server 180 regards a case, in which the vehicle departs from the finally matched coordinate beyond an error range at least five times, as a route deviation, and computes o'clock direction angle up to a coordinate of the current point.

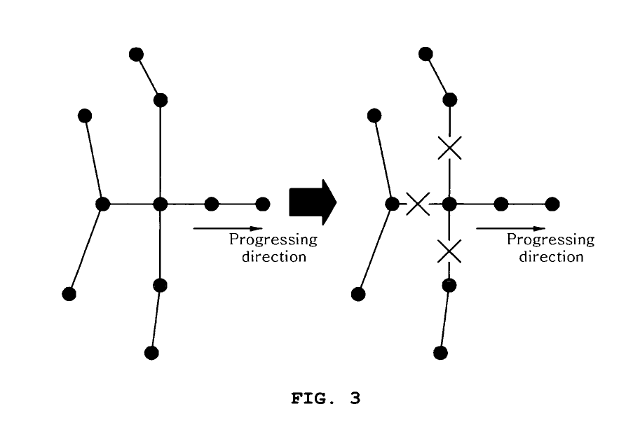

FIG. 3 is a diagram illustrating a method used when the road guidance service server computes the travel route in the progressing direction in the re-search process of the route according to the embodiment of the present invention.

FIG. 3 shows an algorithm used when the road guidance service server 180 blocks connection of nodes adjacent to nodes in the progressing direction of the vehicle in the re-search process of the travel route, and computes the shortest travel route to the destination in the progressing direction of the vehicle, in order to prevent the shortest travel route in an opposite direction other than a straight direction (i.e. the progressing direction of the vehicle) from the current location to the destination from being computed. This is because the vehicle may suddenly travel in the opposite direction while traveling if the road guidance service server does not block the connection of the nodes adjacent to the nodes in the progressing direction of the vehicle in the re-search process of the travel route.

In order for the road guidance service server 180 to compute the travel route in the progressing direction of the vehicle, it is regarded that the connection of the nodes adjacent to the nodes in the progressing direction from the current node is blocked as illustrated in FIG. 3, and the travel route is computed.

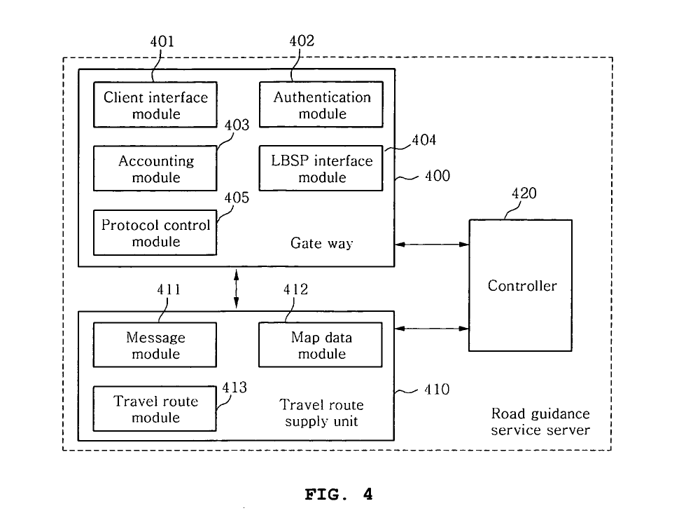

FIG. 4 is a block diagram schematically illustrating the construction of the road guidance service server for providing the road guidance service by means of the MS-Based GPS scheme according to the preferred embodiment of the present invention.

The road guidance service server 180 according to the preferred embodiment of the present invention includes a gateway 400, a travel route supply unit 410, a controller 420, etc.

The gateway 400 receives request signals for the travel route service from the mobile communication terminal 120, generates corresponding contents through inter-working with an authentication module 402, a Location Based System Platform (hereinafter, referred to as LBSP) of a wireless communication network provider, the travel route supply unit 410, etc., and transmits the generated contents to the mobile communication terminal 120.

The gateway 400 includes a client interface module 401, the authentication module 402, an accounting module 403, an LBSP interface module 404, a protocol control module 405, etc.

The client interface module 401 is an interface module for inter-working with the mobile communication terminal 120, maintains or releases with call connection with the mobile communication terminal 120, compresses and decompresses data transmitted/received to/from the mobile communication terminal 120, analyzes a received packet and generates a response packet for response transmission, and decompresses a compressed packet received from the mobile communication terminal 120 or compresses a packet.

The authentication module 402 is a module for authentication for mobile communication terminal users, receives user information from the mobile communication terminal 120 connected in order to use the travel route service, and performs a user authentication function through inter-working between authentication servers of a wireless communication network provider.

The accounting module 403 manages a transmission time for generation of accounting data regarding the use of contents received from the road guidance service server 180, generates an accounting data file of a standard determined by a wireless communication network provider, and transmits the generated accounting data file to the accounting server of the wireless communication network provider.

The LBSP interface module 404 is a module for taking charge of an interface with the LBSP of the wireless communication network provider, and receives the location information of the mobile communication terminal 120 from the LBSP of the wireless communication network provider in order to generate a reference point coordinate for an initial location acquisition and a location correction of the mobile communication terminal 120.

The protocol control module 405 is a module for inter-working with the travel route supply unit 410 of the road guidance service server 180, generates request signals of travel route information, including map data, route data, etc., from the travel route supply unit 410, transmits a request message to the travel route supply unit 410, receives a response message, and performs a conversion according to the form of the corresponding response message.

The travel route supply unit 410 generates the travel route information from the starting point to the destination, which has been requested from the mobile communication terminal 120, and generates data for voice guidance based on the generated travel route information.

The travel route supply unit 410 includes a message module 411, a map data module 412, a travel route module 413, etc.

The message module 411 is a module for taking charge of a communication interface with the gateway 400 of the road guidance service server 180, analyzes data request signals of the gateway 400, operates a detailed module inter-working with the travel route supply unit 410, and transmits result data generated by the travel route supply unit 410 to the gateway 400.

The map data module 412 is a module for providing map data necessary for showing the travel route from the starting point to the destination, which has been requested from the mobile communication terminal 120, receives and analyzes map data request signals of the mobile communication terminal 120, searches for the map data from a map data database, and transmits the map data including a starting point, a destination, a route, etc., to the mobile communication terminal 120.

The travel route module 413 generates route data for showing the travel route from the starting point to the destination, which has been requested from a mobile communication terminal user, generates and processes the travel route information, such as route information, guidance information, etc., for travel guidance by means of the generated route data, and transmits the travel route information to the mobile communication terminal 120 through the gateway 400.

The travel route module 413 computes the shortest travel route by means of the travel route information according to a programmed algorithm.

The controller 420 is a module for controlling the general operation and management of the road guidance service server 180, manages the road guidance service system, receives the travel route information requested by the mobile communication terminal user from the travel route supply unit 410, transmits the received travel route information to the mobile communication terminal 120, analyzes and operates various data, such as authentication information, the shortest travel route and travel route information, and controls the data to be stored as database information.

FIG. 5 is a block diagram schematically illustrating the construction of the mobile communication terminal for providing the road guidance service by means of the MS-Based GPS scheme according to the embodiment of the present invention.

The mobile communication terminal 120 includes a navigation controller 500, a location information controller 510, a communication controller 520, etc.

The mobile communication terminal 120 receives the travel route information, including map data, route data, etc., from the road guidance service server 180, performs travel guidance by voice and text by means of the location information controller 510, the navigation controller 500, the communication controller 520, etc., checks the current location of a mobile communication terminal user, and provides a communication interface for the use of various navigation services.

The navigation controller 500 includes a menu and screen control module 501, a map viewer module 502, a map-matching module 503, a travel guidance module 504, a route display module 505, a map management module 506, a route management module 507, a voice processing module 508, etc.

The menu and screen control module 501 is a module for controlling a menu and a screen in order to receive the travel route service by means of functions of each module through a communication interface with a user. When a route guidance menu management, an input interface of a starting point and a destination, and a travel route are provided, the menu and screen control module 501 manages and controls traffic signposts and symbols, etc., for a map and a route.

The map viewer module 502 outputs an adjacent map including the current location on the LCD screen of the mobile communication terminal 120 by means of map data stored in the mobile communication terminal 120, or map data received from the road guidance service server 180, thereby allowing a user to exactly recognize the current location. The map viewer module 502 controls a data collection and management function for generation of map data to be displayed on the LCD screen of the mobile communication terminal 120, a style management function for managing map graphic attribute information, and a function for displaying a map and a symbol on the LCD screen of the mobile communication terminal 120 while traveling.

In order to display the location of a vehicle while traveling with a coordinate of a map on the LCD screen of the mobile communication terminal 120 by means of a GPS and a terrestrial magnetism, the map-matching module 503 provides a function of matching the vehicle while traveling with a road of the map by means of a coordinate conversion and a correction value. The map-matching module 503 collects the current location through an interface with the travel guidance module 504, converts longitude and latitude coordinates to coordinates of map data, and corrects a value in order to display the current location of the vehicle while traveling, which are received from a coordinate converter, on map data and route data.

The travel guidance module 504 generates voice data from the voice processing module 508 according to the current location generated from the location controller by means of the travel route information received from the road guidance service server 180, and provides the travel route to the voice output means of the mobile communication terminal 120. When providing the travel route, the travel guidance module 504 inter-works with the map viewer module 502 and the route display module 505, thereby causing the mobile communication terminal user to easily travel through the voice guidance, the map and the route viewer.

The route display module 505 inter-works with the travel guidance module 504, and provides the travel route by voice when the vehicle travels. Further, the route display module 505 manages/displays travel and turn information (left turn, right turn, going straight, etc.), displays a time period remaining to a destination by means of distance and speed, displays a distance remaining to the destination by means of a distance of nodes in a route, etc., so that a user can conveniently use the route guidance service to the desired destination.

When map data are stored in the mobile communication terminal 120, the map management module 506 displays the stored map. However, when the map data are not stored in the mobile communication terminal 120, the map management module 506 receives map data from the road guidance service server 180, inter-works with the map viewer module 502, and displays the map on the LCD screen of the mobile communication terminal 120. For a quick search, the map management module 506 generates a space index for space data according to layers by means of the received map, searches for map data through an index manager, transmits the map data to the map viewer module 502, and stores and manages the map data.

The route management module 507 stores and manages the travel route information received from the road guidance service server 180, and searches for and transmits travel route information of a starting point and a destination according to the request of the travel guidance module 504.

The voice processing module 508 understands the current status and progressing direction of a mobile body, and searches for and outputs voice data for safe travel and travel guidance, in order to provide the travel guidance and the safe travel information to the destination.

The communication controller 520 includes a communication control module 521, a message processing module 522, etc.

The communication control module 521 is a module for performing connection maintenance and release functions with the road guidance service server 180 and a data transmission/reception function, and controls a flow of data for navigation data and service function expansibility.

The message processing module 522 is a module for taking charge of a function of classifying and analyzing the message received through the communication control module 521, and branching data to a corresponding module and calling data. The message processing module 522 performs a function of managing an entire data flow of the terminal including a processing for a message, the call of a function of a module for processing a corresponding message, etc.

The location information controller 510 includes a GPS control module 511, a dead reckoning module 512, etc.

The GPS control module 511 receives request signals for the current location information, receives the current location from an MS-Based GPS receiver, and transmits the current location value to a corresponding module. The dead reckoning module. 512 periodically collects location data from a terrestrial magnetism and a GPS for management, extracts the current coordinate by means of distance and angle data of the collected coordinate, and stores and manages a distance and an angle of a previous coordinate.

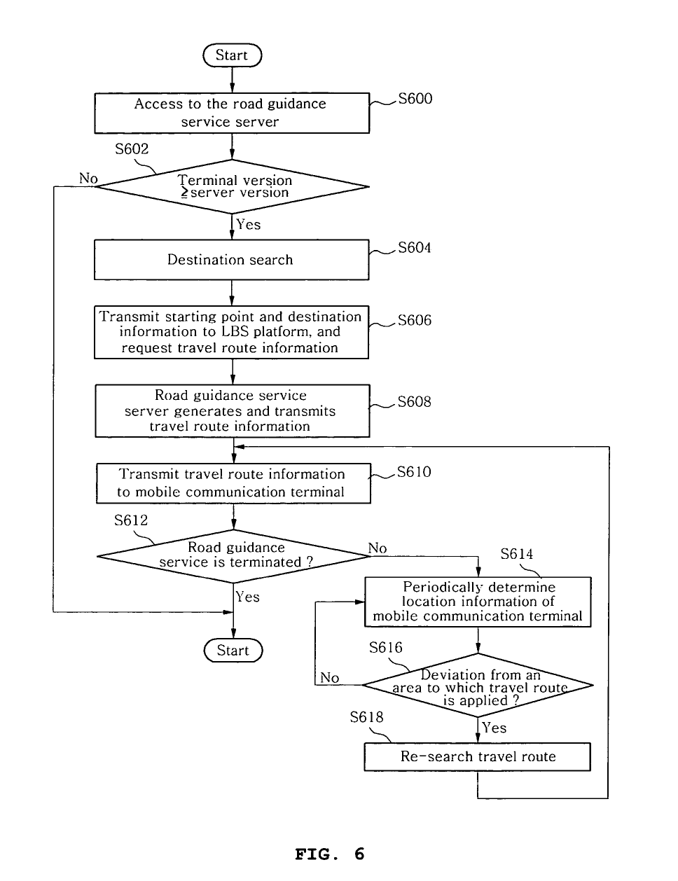

FIG. 6 is a flow diagram schematically illustrating a method for providing the road guidance service by means of the MS-Based GPS scheme according to the preferred embodiment of the present invention.

When a road guidance service mode is selected from a user menu of the mobile communication terminal 120 in a vehicle while traveling in order to receive a travel route service, the mobile communication terminal 120 accesses to the road guidance service server 180 through the mobile communication network (S600). The road guidance service server 180 stores the travel information assistant application used when the road guidance service server 180 receives the location information of the vehicle while traveling, generates travel route information from a starting point of a mobile communication terminal user to a destination, and provides a navigation service to the mobile communication terminal 120. The travel information assistant application may also be stored in a program memory in a production step of the mobile communication terminal 120, or may be downloaded from the road guidance service server 180.

The road guidance service server 180 determines if a server travel information assistant application stored in the server has a version equal to that of a terminal travel information assistant application stored in the mobile communication terminal 120, or determines if the terminal travel information assistant application has a version higher than that of the server travel information assistant application (S602). When the server travel information assistant application has a version equal to that of the terminal travel information assistant application, or when the terminal travel information assistant application has a version higher than that of the server travel information assistant application, the road guidance service server 180 searches for or inputs destination information desired by a mobile communication terminal user by means of an input means (S604). The input means may include a microphone for recognizing user's voice, a touch screen, a key input unit for character recognition, etc. The mobile communication terminal 120 transmits starting point and destination information to the LBS platform 170 through the mobile communication network, and requests the road guidance service server 180 inter-working with the LBS platform 170 to transmit travel route information (S606). Then, the road guidance service server 180 generates travel route information including the shortest travel route from the current location to a destination according to a programmed algorithm, and transmits the generated travel route information to the mobile communication terminal 120 through the mobile communication network (S608). The mobile communication terminal 120 outputs various travel route information including map data, route data, etc., necessary for the travel of a vehicle, through a display unit, and outputs travel information by voice according to travel locations (S610). The mobile communication terminal user drives the vehicle to the destination according to the travel route and voice guidance outputted from the mobile communication terminal 120, and determines if termination signals of the road guidance service are received on the way to the destination (S612). If the connection with the mobile communication network is terminated, the road guidance service is terminated. In the case of continuously using the road guidance service, the mobile communication terminal 120 periodically determines its own location (S614). The road guidance service server 180 determines if the newly determined location has deviated from an area to which the travel route received from the road guidance service server 180 is applied (S616). When the newly determined location belongs to the area to which the travel route received from the road guidance service server 180 is applied, the road guidance service server 180 repeats a process for periodically determining the location information of the mobile communication terminal 120. However, when the newly determined location has deviated from the area to which the travel route is applied, the road guidance service server 180 re-searches for a travel route to the destination in the progressing direction of the vehicle (S618). For this, when the mobile communication terminal 120 transmits the current location coordinate, a destination coordinate, an o'clock direction angle in the progressing direction, a road type, etc., to the road guidance service server 180, the road guidance service server 180 searches for links of the o'clock direction angle and computes a travel route. Then, the road guidance service server 180 generates travel route information again and provides the generated travel route information to the mobile communication terminal 120 through the mobile communication network.

According to the present invention as descried above, in the case of using a navigation service, which is a road guidance service, it is possible to provide the navigation service to only a mobile communication terminal without a separate GPS kit.

According to the present invention as descried above, since a road guidance service is provided through a program stored in a mobile communication terminal, a separate apparatus is not necessary. Accordingly, the mobility of the mobile communication terminal is improved. Since it is not necessary to purchase an expensive GPS kit, the cost can be reduced.

According to the present invention as descried above, a search area (MBR and the Heuristic areas) is expanded through a Dijkstra algorithm, which has employed R-Tree concept, and the shortest travel route is computed, so that it is possible to compute a travel route quickly and efficiently.

Further, according to the present invention as descried above, since connection of nodes adjacent to nodes in a progressing direction of a vehicle is blocked in a process of re-searching for a travel route, and the shortest travel route to a destination is computed in the progressing direction of the vehicle, it is possible to prevent a case in which the vehicle must suddenly proceed to an opposite direction while traveling from occurring.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for providing a navigation service by means of a Mobile Station (MS) MS-Based Global Positioning System (GPS) scheme in a mobile communication system including a mobile communication terminal, a Positioning Determination Entity (PDE), a Location Based Services (LBS) platform and a road guidance service server, the method comprising the steps of:
(a) the road guidance service server selecting a road guidance service mode, receiving information of a starting point and a destination of the mobile communication terminal through the LBS platform via a mobile communication network, and receiving request signals for travel route information; and
(b) generating the travel route information according to the received request signals, and transmitting the travel route information to the mobile communication terminal through the mobile communication network,
wherein the road guidance service server computes a shortest travel route by means of a Dijkstra algorithm based on a R-Tree, transmits the shortest travel route to the mobile communication terminal, and, when a vehicle deviates from a travel route received from the road guidance service server during traveling, the road guidance service server re-searches for a route to the destination in a progressing direction of the vehicle, and transmits the re-searched travel route to the mobile communication terminal.

2. The method according to claim 1, further comprising a step of c) after the mobile communication terminal selects the road guidance service mode and accesses to the road guidance service server, the road guidance service server determining if a server travel information assistant application stored in the road guidance service server has a version equal to a version of a terminal travel information assistant application stored in the mobile communication terminal, or the terminal travel information assistant application has a version higher than the version of the server travel information assistant application.

3. The method according to claim 1, further comprising a step of d) outputting the travel route information to the mobile communication terminal, determining that the mobile communication terminal continuously uses the road guidance service as a result of determination regarding whether termination signals of the road guidance service are received, periodically determining location information of the mobile communication terminal, determining if the newly determined location has deviated from an area to which the travel route received from the road guidance service server is applied, generating the re-searched travel route to the destination from a current location in the progressing direction of the vehicle when it is determined that the newly determined location has deviated from the area to which the travel route is applied, and transmitting the generated travel route to the mobile communication terminal.

4. The method according to claim 3, wherein the travel route information includes both route planning data containing a search area, map data and route data and route guidance data containing a shortest travel route, a voice guidance type, a road type, a link index, the search area containing starting point and destination coordinates.

5. The method according to claim 1, wherein, in a scheme by which the road guidance service server computes the shortest travel route by means of the Dijkstra algorithm based on the R-Tree, the starting point and the destination are set as a search area of a Minimum Bounding Rectangle (MBR) area and a Heuristic area, which have employed the R-Tree, and the shortest travel route from the starting point to the destination is computed in the set search area by means of the Dijkstra algorithm.

6. The method according to claim 1, wherein, in a process in which the road guidance service server re-searches the travel route, the road guidance service server blocks connection of nodes adjacent to nodes in the progressing direction of the vehicle, and computes the re-searched travel route, in order to prevent the shortest travel route in an opposite direction other than a straight direction (i.e. the progressing direction of the vehicle) from the starting point to the destination from being computed.

7. The method according to claim 6, wherein, when the vehicle deviates from the travel route during traveling in a process of re-searching for the travel route, the road guidance service server regards a case, in which the vehicle departs from a finally matched coordinate beyond an error range at least five times, as a route deviation, searches for links of an o'clock direction angle from a coordinate of the current point, and computes the re-searched travel route.

8. A system for providing a navigation service by means of a Mobile Station (MS) MS-Based Global Positioning System (GPS) scheme, the system comprising:
a mobile communication terminal for receiving GPS electric wave from a GPS artificial satellite by means of aiding data received through a mobile communication network, determining location information of a user, transmitting the determined location information through the mobile communication network, and receiving and outputting travel route information from a starting point, which corresponds to the location information, to a destination;
a Positioning Determination Entity (PDE) for generating the aiding data by means of Mobile Station (MS) information received from the mobile communication terminal, and transmitting the generated aiding data to the mobile communication terminal;
a road guidance service server for receiving the location information, generating the travel route information from the starting point to the destination by means of the received location information, and transmitting the generated travel route information to the mobile communication terminal; and
a Location Based Services (LBS) platform for receiving the location information from the mobile communication terminal, transmitting the received location information to the road guidance service server, transmitting request signals of the mobile communication terminal for the travel route information from the starting point to the destination to the road guidance service server, receiving the travel route information, and transmitting the received travel route information to the mobile communication terminal,
wherein the road guidance service server computes a shortest travel route by means of a Dijkstra algorithm based on a R-Tree, transmits the shortest travel route to the mobile communication terminal, and, when a vehicle deviates from a travel route received from the road guidance service server during traveling, the road guidance service server re-searches for a route to the destination in a progressing direction of the vehicle, and transmits the re-searched travel route to the mobile communication terminal.

9. A road guidance service server for receiving determined location information from a mobile communication terminal, generating a shortest travel route from a starting point to a destination, which is desired by a user, transmitting the generated the shortest travel route to the mobile communication terminal, thereby providing a travel route service, the road guidance service server comprising:
a travel route supply unit for generating travel route information from the starting point to the destination, which has been requested by the mobile communication terminal, and generating data for voice guidance based on the generated travel route information;
a gateway for receiving request signals for the travel route service from the mobile communication terminal, generating the travel route information through inter-working with an authentication server, an accounting server, a Location Based System Platform (LBSP) of a wireless communication network provider, the travel route supply unit, and transmitting the generated travel route information to the mobile communication terminal; and
a controller for controlling a general processor operation and management of the road guidance service server, analyzing and operating materials generated from various modules included in the road guidance service server, storing the analyzed materials as database information for management, and controlling the travel route information necessary for traveling of a vehicle to be transmitted to the mobile communication terminal.

10. The road guidance service server according to claim 9, wherein the gateway comprises:
a client interface module for performing a communication interface in order to inter-work with the mobile communication terminal, maintaining or releasing with call connection with the mobile communication terminal, compressing and decompressing data transmitted/received to/from the mobile communication terminal;
an authentication module for performing an authentication function through inter-working with the authentication server of the wireless communication network provider for user authentication of the mobile communication terminal;
an accounting module for generating an accounting data file for contents usage of the mobile communication terminal, and transmitting the generated accounting data file to the mobile communication terminal;
an LBSP interface module for performing a communication interface function with the LBSP of the wireless communication network provider, and receiving location information for acquiring a reference coordinate from the LBSP, the reference coordinate being used for an initial location acquisition and a location correction of the mobile communication terminal; and
a protocol control module for inter-working with the travel route supply unit, generating request signals of the travel route information, transmitting the request signals to the travel route supply unit, and converting response signals received from the travel route supply unit into a response message.

11. The road guidance service server according to claim 10, wherein the travel route supply unit comprises:
a message module for taking charge of a communication interface with the gateway, analyzing data request signals of the gateway, operating a module within the travel route supply unit, and transmitting result data generated by the travel route supply unit to the gateway;
a map data module for providing map data necessary for showing the travel route from the starting point to the destination, which has been requested from the mobile communication terminal; and
a travel route module for generating route data for showing the travel route from the starting point to the destination, which has been requested from the mobile communication terminal, generating and processing the travel route information, including route information and guidance information for travel guidance, by means of the generated route data, and transmitting the travel route information to the mobile communication terminal through the gateway.

12. The road guidance service server according to claim 11, wherein the travel route information includes both route planning data containing a search area, map data and route data and route guidance data containing a shortest travel route, a voice guidance type, a road type, a link index, the search area containing starting point and destination coordinates.

13. The road guidance service server according to claim 9, wherein, in a scheme by which the road guidance service server computes the shortest travel route by means of the Dijkstra algorithm based on the R-Tree, the starting point and the destination are set as a search area of a Minimum Bounding Rectangle (MBR) area and a Heuristic area, which have employed the R-Tree, and the shortest travel route from the starting point to the destination is computed in the set search area by means of the Dijkstra algorithm.

14. The road guidance service server according to claim 9, wherein, in a process in which the road guidance service server re-searches the travel route, the road guidance service server blocks connection of nodes adjacent to nodes in the progressing direction of the vehicle, and computes the re-searched travel route, in order to prevent the shortest travel route in an opposite direction other than a straight direction (i.e. the progressing direction of the vehicle) from the starting point to the destination from being computed.

15. The road guidance service server according to claim 14, wherein, when the vehicle deviates from the travel route during traveling in a process of re-searching for the travel route, the road guidance service server regards a case, in which the vehicle departs from a finally matched coordinate beyond an error range at least five times, as a route deviation, searches for links of an o'clock direction angle from a coordinate of the current point, and computes the re-searched travel route.

16. A mobile communication terminal for determining location information from a GPS artificial satellite by means of aiding data received from a road guidance service server, transmitting the location information, requesting the road guidance service server to transmit travel route information from a starting point to a destination, which is desired by a user, receiving the travel route information from the road guidance service server, and transmitting the travel route information, the mobile communication terminal comprising:
a communication controller for maintaining and releasing call connection with the road guidance service server, and managing and controlling a flow of transmitted/received data;
a navigation controller for receiving the travel route information from the starting point to the destination from the road guidance service server, storing, processing and managing the received travel route information, and displaying the travel route from the starting point to the destination on a LCD screen of the mobile communication terminal by voice, a map and a route; and
a location information controller for receiving request signals for a current location information, determining the location information from the GPS artificial satellite, transmitting the location information to a corresponding module, and storing and managing distance and angle data of periodically collected coordinates.

17. The mobile communication terminal according to claim 16, wherein the navigation controller comprises:
a menu and screen control module for managing and controlling a menu and a screen used for providing a travel route service by means of functions of each module through a communication interface with the user;
a map viewer module for outputting an adjacent map including a current location on the LCD screen of the mobile communication terminal through a data collection and management for generation of map data to be displayed on the LCD screen of the mobile communication terminal;
a map-matching module for matching a location of a vehicle during traveling with a road of the map by means of a coordinate conversion and a correction value in order to display the location of the vehicle by means of coordinates of the map displayed on the LCD screen of the mobile communication terminal;
a voice processing module for understanding a current status and progressing direction of a mobile body, and searching for and outputting voice data for safe travel and travel guidance in order to provide travel guidance and safe travel information to the destination;
a travel guidance module for generating voice data from the voice processing module according to the current location generated from the location controller by means of the travel route information received from the road guidance service server, and providing a travel route to a voice output means of the mobile communication terminal;
a route display module for inter-working with the travel guidance module, displaying the travel route by voice when the vehicle travels, outputting distance information, time information and route information, and performing a route guidance function to the destination;
a map management module for searching for the map data in an area, in which the vehicle travels, through inter-working with the map viewer module for output, and storing and managing the map data;
a route management module for storing and managing the travel route information received from the road guidance service server, and searching for and transmitting the travel route information of the starting point and the destination according to a request of the travel guidance module.

18. The mobile communication terminal according to claim 16, wherein the communication controller comprises:
a communication control module for maintaining and releasing connection with the road guidance service server, and performing a data transmission/reception function for navigation data and service function expansibility; and
a message processing module for analyzing and classifying the data received through the communication control module, calling a corresponding module, and managing a general flow of data in the mobile communication terminal.

19. The mobile communication terminal according to claim 16, wherein the location information controller comprises:
a GPS control module for receiving the request signals for the current location information, receiving a current location from an MS-Based GPS receiver, and transmitting the current location to a corresponding module requiring the location information; and
a dead reckoning module for periodically collecting location data from a terrestrial magnetism and a GPS for management, extracting a current coordinate by means of distance and angle data of the collected coordinate, and storing and managing a distance and an angle of a previous coordinate.
